(19) United States
(12) Patent Application Publication
(10) Pub. No.: US 2025/0083222 A1
(43) Pub. Date: Mar. 13, 2025

(54) TORPEDO CARS FOR USE WITH GRANULATED METALLIC UNIT PRODUCTION, AND ASSOCIATED SYSTEMS, DEVICES, AND METHODS

(71) Applicant: SUNCOKE TECHNOLOGY AND DEVELOPMENT LLC, Lisle, IL (US)

(72) Inventors: John Francis QUANCI, Haddonfield, NJ (US); John Michael RICHARDSON, Devon, PA (US); Patrick James MULLARKEY, Manhattan, IL (US); David James SCHWAKE, Aurora, IL (US); Andrew Michael BUTOR, Cranberry Township, PA (US); Jonathan Hale PERKINS, Lisle, IL (US); Chun Wai CHOI, Lisle, IL (US); Milos J. KAPLAREVIC, Naperville, IL (US)

(21) Appl. No.: 18/882,531

(22) Filed: Sep. 11, 2024

Related U.S. Application Data
(60) Provisional application No. 63/581,946, filed on Sep. 11, 2023.

(51) Int. Cl. B22D 41/12; B22F 9/08

(52) U.S. Cl. CPC B22D 41/12; B22F 9/08; B22F 2301/35

(57) ABSTRACT

Torpedo cars for use with granulated iron production, and associated systems, devices, and methods are disclosed herein. In some embodiments of the present technology, a torpedo car includes a tilting mechanism, a body rotatably coupled to the tilting mechanism, and a controller operably coupled to the tilting mechanism to control tilting of the body. The body can include (i) an inner surface defining a cavity and a channel, and (ii) an outer surface defining an opening to the cavity and a channel outlet of the channel spaced apart from the opening. The channel can extend between the channel outlet and a channel inlet interfacing the cavity. The inner surface can include a slag dam configured to prevent slag from exiting the opening while the torpedo car tilts. The controller can control the tilting mechanism to control molten metal flow out of the cavity through the channel.

### CROSS-REFERENCE TO RELATED APPLICATION(S)

The present application claims the benefit of U.S. Provisional Patent Application No. 63/581,946, filed Sep. 11, 2023, and titled “SYSTEM AND METHOD FOR CONTINUOUS GRANULATED PIG IRON (GPI) PRODUCTION,” the disclosure of which is incorporated herein by reference in its entirety. The present application is related to the following applications, the disclosures of which are incorporated herein by reference in their entireties: U.S. patent application Ser. No. 18/882,116 [Attorney Docket No. 084553.8072.US00], filed Sep. 11, 2024, and titled “RAILCARS FOR TRANSPORTING GRANULATED METALLIC UNITS, AND ASSOCIATED SYSTEMS, DEVICES, AND METHODS”; U.S. patent application Ser. No. 18/882,045 [Attorney Docket No. 084553.8073.US00], filed Sep. 11, 2024, and titled “LOADING GRANULATED METALLIC UNITS INTO RAILCARS, AND ASSOCIATED SYSTEMS, DEVICES, AND METHODS”; U.S. patent application Ser. No. 18/882,191 [Attorney Docket No. 084553.8074.US00], filed Sep. 11, 2024, and titled “LOW-SULFUR GRANULATED METALLIC UNITS, AND ASSOCIATED SYSTEMS, DEVICES, AND METHODS”; U.S. patent application Ser. No. 18/882,638 [Attorney Docket No. 084553.8075.US00], filed Sep. 11, 2024, and titled “CONTINUOUS GRANULATED METALLIC UNITS PRODUCTION, AND ASSOCIATED SYSTEMS, DEVICES, AND METHODS”; U.S. patent application Ser. No. 18/882,661 [Attorney Docket No. 084553.8076.US00], filed Sep. 11, 2024, and titled “USE OF A BASIC OXYGEN FURNACE TO PRODUCE GRANULATED METALLIC UNITS, AND ASSOCIATED SYSTEMS, DEVICES, AND METHODS”; U.S. patent application Ser. No. 18/882,256 [Attorney Docket No. 084553.8077.US00], filed Sep. 11, 2024, and titled “LOW-CARBON GRANULATED IRON, AND ASSOCIATED SYSTEMS, DEVICES, AND METHODS”; U.S. patent application Ser. No. 18/882,384 [Attorney Docket No. 084553.8079.US00], filed Sep. 11, 2024, and titled “TREATING COOLING WATER IN IRON PRODUCTION FACILITIES, AND ASSOCIATED SYSTEMS, DEVICES, AND METHODS”; U.S. patent application Ser. No. 18/882,465 [Attorney Docket No. 084553.8080.US00], filed Sep. 11, 2024, and titled “USE OF RESIDUAL IRON WITHIN GRANULATED METALLIC UNIT PRODUCTION FACILITIES, AND ASSOCIATED SYSTEMS, DEVICES, AND METHODS”; U.S. patent application Ser. No. 18/882,501 [Attorney Docket No. 084553.8081.US00], filed Sep. 11, 2024, and titled “PROCESSING GRANULATED METALLIC UNITS WITHIN ELECTRIC ARC FURNACES, AND ASSOCIATED SYSTEMS AND METHODS”.

### TECHNICAL FIELD

The present technology generally relates to torpedo cars for use with granulated metallic unit production, and associated systems, devices, and methods.

### BACKGROUND

Granulated pig iron (GPI) is a form of iron that is granulated into small, uniform particles, making it easier to handle, transport, and use in different metallurgical processes compared to conventional iron. The demand for GPI has been steadily increasing due to its versatile applications in various industries, including automotive, construction, and manufacturing. The growing popularity of GPI can be attributed to its high purity, consistent quality, and the efficiency it brings to the production of steel and other iron-based products.

Granulated pig iron is produced by rapidly cooling molten iron with water, resulting in the formation of granules. This process, known as granulation, is typically carried out downstream of blast furnaces. However, current production methods are often characterized by intermittent production cycles due to various operational constraints, such as the need for periodic maintenance, fluctuations in raw material supply, and energy consumption issues. These interruptions not only affect the overall efficiency but also lead to increased production costs and variability in product quality. Therefore, there is a need for an improved production process that can ensure continuous and stable granulation of iron, thereby enhancing productivity and reducing operational costs.

### BRIEF DESCRIPTION OF THE DRAWINGS

Features, aspects, and advantages of the presently disclosed technology may be better understood with regard to the following drawings.

FIG. 1 is a schematic block diagram of a continuous granulated metallic unit (GMU) production system configured in accordance with embodiments of the present technology.

FIG. 2 is a plan view of the continuous GMU production system of FIG. 1, configured in accordance with embodiments of the present technology.

FIG. 3 is an enlarged view of the continuous GMU production system of FIG. 2.

FIGS. 4A and 4B are top and side views, respectively, of a torpedo car configured in accordance with embodiments of the present technology.

FIG. 5 is an enlarged view of the torpedo car of FIG. 4A.

FIGS. 6A, 6B, and 6C are enlarged perspective, enlarged front, and cross-sectional side views, respectively, of a torpedo car having a first channel outlet shape and configured in accordance with embodiments of the present technology.

FIGS. 7A, 7B, and 7C are enlarged perspective, enlarged front, and cross-sectional side views, respectively, of a torpedo car having a second channel outlet shape and configured in accordance with embodiments of the present technology.

FIGS. 8A, 8B, and 8C are enlarged perspective, enlarged front, and cross-sectional side views, respectively, of a torpedo car having a third channel outlet shape and configured in accordance with embodiments of the present technology.

FIGS. 9A-10B illustrate various channel outlet shapes configured in accordance with embodiments of the present technology.

FIG. 11 is a perspective view of an extension member coupleable to a torpedo car and configured in accordance with embodiments of the present technology.

FIGS. 12A-12F are cross-sectional side views of a torpedo car tilted at various angles in accordance with embodiments of the present technology.

FIG. 13 is a cross-sectional side view of a torpedo car tilted to pour molten metallics out in accordance with embodiments of the present technology.

FIG. 14 is a flowchart illustrating a method for operating a torpedo car for use with granulated iron production in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

The present technology is generally directed to systems, devices, and methods for torpedo cars for use with granulated metallic unit (GMU) production. GMU can be produced by forming molten iron in a blast furnace and rapidly cooling the molten iron with water to form granules. The equipment for granulating molten iron can be located far away from the blast furnace used to produce the molten iron. Therefore, it can be necessary to transport the molten iron therebetween. However, transferring the molten iron between different places and/or equipment using conventional devices can result significant material loss (e.g., via spilling) and/or transfer of excessive quantities of impurities such as slag. Moreover, conventional devices may be unable to meet the production rate demands of continuous granulated iron production systems.

Embodiments of the present technology address at least some of the above-described issues by providing a torpedo car including a tilting mechanism, a body rotatably coupled to the tilting mechanism, and a controller operably coupled to the tilting mechanism to control tilting of the body. The body can include (i) an inner surface defining a cavity and a channel, and (ii) an outer surface defining an opening to the cavity and a channel outlet of the channel spaced apart from the opening. The cavity can be configured to store molten metal/metallics received through the opening. The channel can extend between the channel outlet and a channel inlet interfacing the cavity. The controller can control the tilting mechanism such that as the body tilts, the molten iron flows out of the cavity through the channel. Moreover, in some embodiments, the tilting of the torpedo car is part of a feedback loop system that considers various measurements taken downstream of the torpedo car.

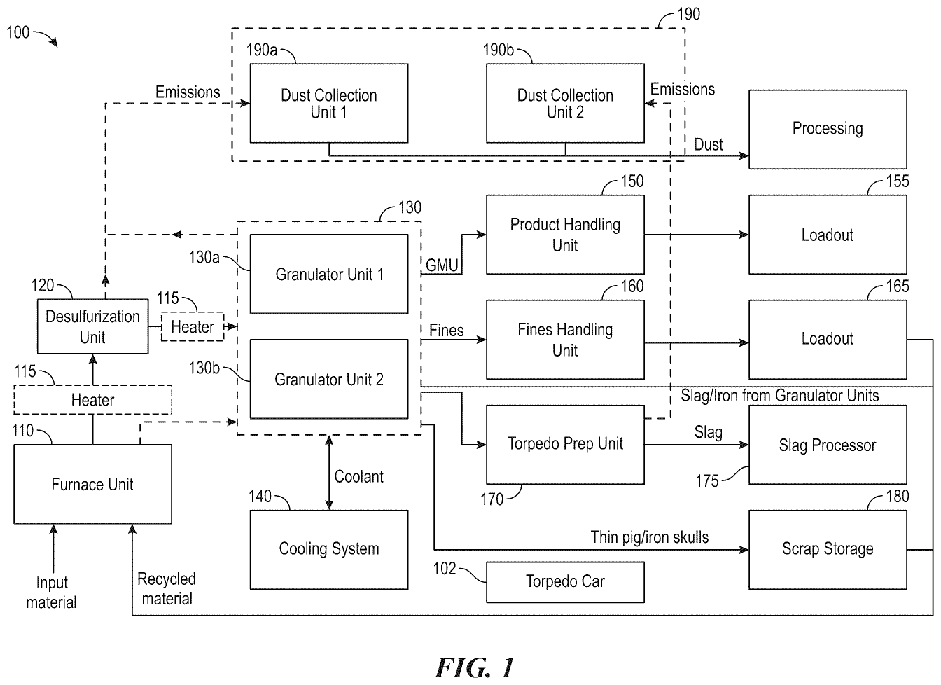

Specific details of several embodiments of the technology are described below with reference to FIGS. 1-14. Other details describing well-known structures and systems often associated with furnaces, rails, conveyor belts, emission hoods, automated control systems, etc. have not been set forth in the following disclosure to avoid unnecessarily obscuring the description of the various embodiments of the technology. Many of the details, dimensions, angles, and other features shown in the Figures are merely illustrative of particular embodiments of the technology. Accordingly, other embodiments can have other details, dimensions, angles, and features without departing from the spirit or scope of the present technology. A person of ordinary skill in the art, therefore, will accordingly understand that the technology may have other embodiments with additional elements, or the technology may have other embodiments without several of the features shown and described below with reference to FIGS. 1-14.

### II. Embodiments of a Continuous Granulated Metallic Unit Production System

FIG. 1 is a schematic block diagram of a continuous GMU production system 100 (“the system 100”) configured in accordance with embodiments of the present technology. As explained elsewhere herein, GMUs can include granulated iron (GI), granulated pig iron (GPI), granulated steel (GS), or GMU. Relatedly, molten metallics can include molten pig iron or molten steel. As used herein, the term “continuous” should be interpreted to mean continuous operations cycles, including in batch or semi-batch operations, for at least 2 hours, 4 hours, 6 hours, 8 hours, 10 hours, 12 hours, 16 hours, 20 hours, or 24 hours. The duration of the continuous operations cycles can depend at least in part on the size of the GMU to be produced by the system 100. The system 100 can include a furnace unit 110, a desulfurization unit 120, granulator units 130 including a first granulator unit 130a and a second granulator unit 130b, and a cooling system 140. The furnace unit 110 can receive input materials (e.g., iron ore, coke, limestone, and/or preheated air) and/or recycled material, which can be sourced from downstream components of the system 100 as described in further detail herein. Equations (1)-(6) below detail some of the chemical processes controlled at the furnace unit.

C+O₂→CO₂ (1)

CO₂+C->2CO (2)

Fe₂O₃+3CO→2Fe+3CO₂ (3)

Fe₂O₃+3C→2Fe+3CO (4)

CaCO₃→CaO+CO₂ (5)

CaO+SiO₂→CaSiO₃ (6)

Equation (1) represents the combustion of coke, which is a form of carbon. When coke reacts with oxygen gas introduced into the furnace (e.g., via an oxygen lance), it forms carbon dioxide. This exothermic reaction releases a significant amount of heat, which is essential for maintaining the high temperatures required for subsequent reactions. The carbon dioxide produced via Equation (1) further reacts with additional coke to form carbon monoxide, as illustrated by Equation (2). This endothermic reaction helps to moderate the temperature within the furnace unit 110. Equations (3) and (4) represent the reduction of iron ore (Fe₂O₃). As illustrated by Equation (3), the iron oxide reacts with the carbon monoxide produced via Equation (2), which acts as a reducing agent to convert iron ore into iron and produces carbon dioxide as a byproduct. Alternatively, as illustrated by Equation (4), the iron ore may be reduced directly by the coke, albeit less commonly. Equations (5) and (6) represent the formation of slag. As illustrated by Equation (5), the calcium carbonate/limestone (CaCO₃) can decompose into calcium oxide and carbon dioxide at the high temperatures of the furnace unit 110. As illustrated by Equation (6), the calcium oxide can then react with silica (SiO₂), an impurity in the iron ore, to form calcium silicate (CaSiO₃), also known as slag. The furnace unit 110 can output molten metallics (from Equations (3) and (4)) and slag (from Equations (5) and (6)).

In some embodiments, the input materials (e.g., the coke, the iron ore, and/or the limestone) include sulfur, which can remain in the molten metallics output by the furnace unit 110. A torpedo car 102 or other transfer vessel can transfer the molten metallics from the furnace unit 110 to the desulfurization unit 120. The desulfurization unit 120 can include equipment to reduce the sulfur content of the molten metallics. For example, one or more lances can be used to deliver magnesium (Mg), calcium carbide (CaC₂), or other sulfur-reducing agent to the molten metallics. In some embodiments, the molten metallics are desulfurized while remaining inside the torpedo car 102. Equations (7) and (8) below detail the reactions between the sulfur and the sulfur-reducing agents.

Mg+S→MgS (7)

CaC₂+S→CaS+2C (8)

The resulting substances, including magnesium sulfide (MgS) and calcium sulfide (CaS), are not soluble in molten metallics and will therefore be in solid form (e.g., as solid particles) that can be more readily removed at the desulfurization unit 120 and/or further downstream. As discussed further herein, reducing the sulfur content can increase the quality of the GMU product and/or allow the production process to be continuous. After the desulfurization process, the torpedo car 102 or other transfer vessel (e.g., a ladle) can transfer the molten metallics from the desulfurization unit 120 to the granulator units 130. In some embodiments, as indicated by the dashed arrow, the desulfurization unit 120 is bypassed and the molten metallics are transferred directly from the furnace unit 110 to the granulator units 130. Notably, conventional facilities may not include a desulfurization unit or may otherwise lack the ability to desulfurize molten metallics. One reason for this is that conventional steelmaking facilities directly feed molten metallics from blast furnaces to basic oxygen furnaces, and opt to granulate the molten metallics only when the basic oxygen furnaces are down. Because producing GPI is a backup operation for such facilities, the added complexity and costs associated with establishing desulfurization equipment may not be economical.

In some embodiments, the temperature of the molten metallics are within a predetermined range prior to reaching the granulator units 130. For example, maintaining the molten metallics in a sufficiently fluid state can better ensure the formation of uniform granules and help avoid premature solidification, which can lead to irregular granule shapes and sizes. In some embodiments, the system includes one or more heaters 115 before and/or after the desulfurization unit 120, e.g., to reheat the molten metallics within the torpedo car 102. For example, if the temperature of the molten metallics are below a threshold temperature value, the heater 115 can be used to raise the temperature of the molten metallics in the torpedo car 102 to be within a desired temperature range. The threshold temperature value can vary between different compositions, and can be between 2300-2500° F., between 2300-2400° F., or between 2340-2350° F. Additionally or alternatively, the threshold temperature can be at least 100° F., 200° F., 300° F., or 400° F. above a solidification temperature, depending on a chemical makeup of the composition. In some embodiments, the heater 115 comprises one or more oxygen lances.

The torpedo car 102 can transfer the molten metallics to one of the granulator units 130. While FIG. 1 illustrates two granulator units 130, it will be understood that the system 100 can include one, three, four, five, six, or more granulator units 130. The granulator units 130 can each include a granulation reactor that receives and granulates molten metallics to form granulated products. For example, the granulation reactor can include a cavity that holds a coolant, and the molten metallics can be transferred (e.g., poured, sprayed) onto a target of the reactor holding the water. The water can be maintained at a sufficiently low temperature by the cooling system 140 (e.g., cooled directly by pumping the water between the granulator units 130 and the cooling system 140, cooled indirectly by pumping a coolant separate from the water that receives the molten metallics). In some embodiments, the granulator units 130 each includes one or more components for controlling the flow of molten metallics from the torpedo car 102 to the granulation reactor. As one of ordinary skill in the art will appreciate, flow control can affect the shape, size, and quality of the granulated products. The granulator units 130 can also include a dewatering assembly for drying the granulated products from the granulation reactor to output GMU. The granulator units 130 can further include a classifier assembly for filtering the filtrate from the dewatering assembly to output fines.

The system 100 can further include a product handing unit 150 to receive the GMU output by the granulator units 130 (e.g., by the dewatering assembly), and a loadout 155 downstream of the product handling unit 150. Additionally, the system 100 can further include a fines handling unit 160 to receive the fines output by the granulator units 130 (e.g., by the classifier assembly), and a loadout 165 downstream of the fines handling unit 160. In some embodiments, the product handling unit 150 and/or the fines handling unit 160 each includes one or more conveyor belts, diverters, stockpile locations, etc. The system 100 can additionally include a torpedo preparation unit 170 that can remove slag and/or kish from the torpedo car 102. For example, the torpedo car 102, after delivering the molten metallics to the granulator units 130, can proceed to the torpedo prep unit 170 to be cleaned or otherwise prepared for the next cycle of transferring molten metallics. The removed slag can be subsequently transferred to a slag processor 175. The system 100 can further include a scrap storage 180 that can receive thin pig and/or iron skulls from the granulator units 130.

As shown in FIG. 1, the fines at the loadout 165, slag and/or iron from the granulator units 130, and/or the thin pig and/or iron skulls at the scrap storage 180 can be fed back into the furnace unit 110 as recycled materials. In some embodiments, the recycled materials are processed (e.g., pelletized) prior to being fed into the furnace unit 110. Furthermore, emissions from various components of the system 100 can be collected and directed towards a dust collection unit 190 (e.g., a baghouse, a scrubber, etc.). In FIG. 1, for example, the emissions from the desulfurization unit 120 and the granulator units 130 are directed to a first dust collection unit 190a, and the emissions from the torpedo prep unit 170 are directed to a second dust collection unit 190b. Each of the dust collection units 190 can filter the emissions to remove dust therefrom so that clean waste gas is sent to stacks (not shown) to be released into the atmosphere, and the removed dust can be directed to further processing.

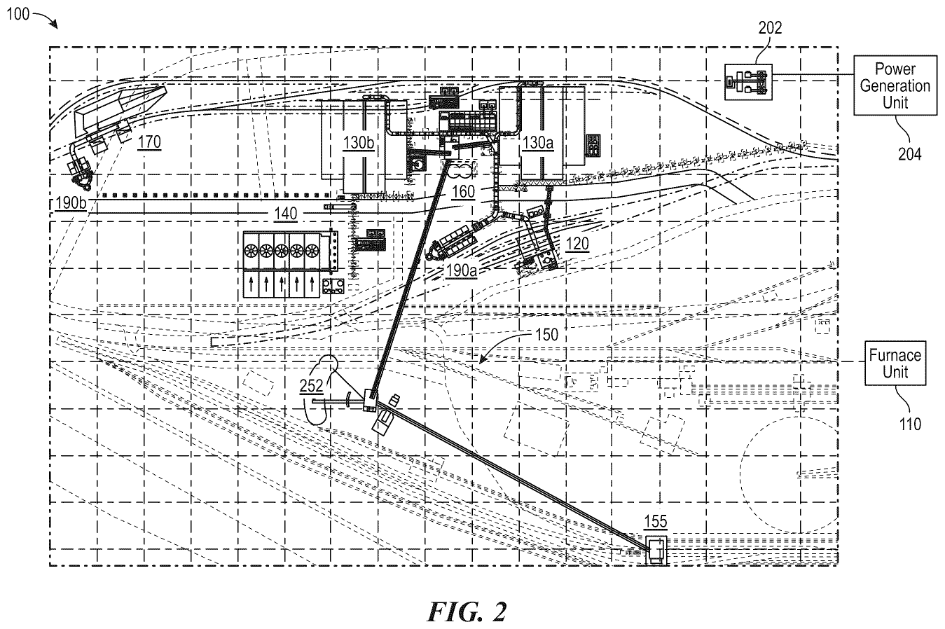

FIG. 2 is a plan view of the continuous GMU production system 100. It will be appreciated that the plan view illustrated in FIG. 2 is merely one example, and that the components of the system 100 can be arranged differently in other embodiments. As shown, the system 100 can further include an electrical building 202 and a power generation unit 204 for providing electrical power to the system 100. As discussed further herein, one or more of the components of the system 100 can be powered electrically and/or hydraulically. The furnace unit 110 can be located away from many of the other components of the system 100. The torpedo car 102 or other transfer vessel (not shown) can transfer the molten metallics from the furnace unit 110 to the desulfurization unit 120 along tracks illustrated in dashed lines.

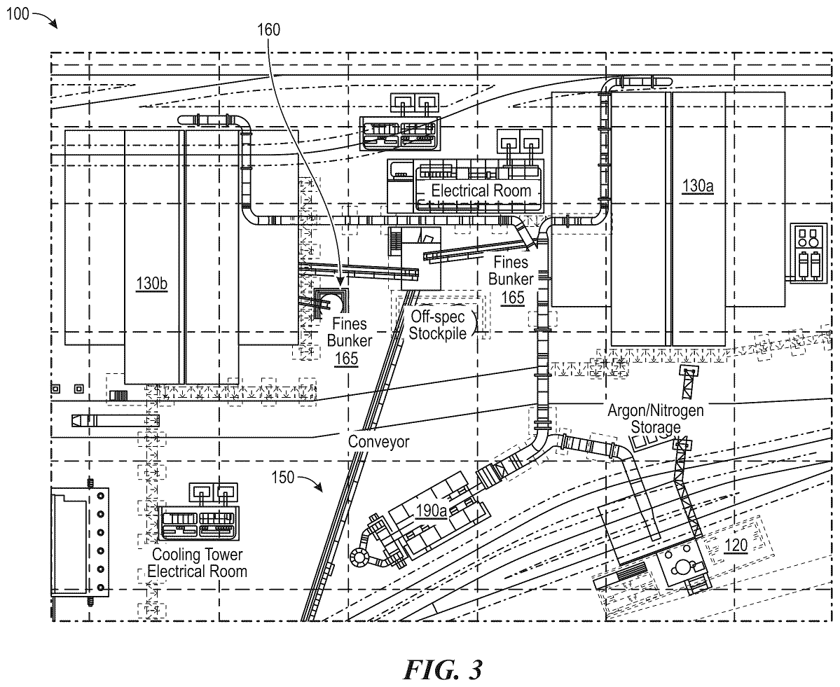

Referring momentarily to FIG. 3, which is an enlarged plan view of the system 100, the desulfurization unit 120 can desulfurize the molten metallics while the molten metallics remains in the torpedo car 102. Once the molten metallics are desulfurized, the torpedo car 102 can continue along the tracks to the granulator units 130. The torpedo car 102 can deliver the molten metallics to either of the first granulator unit 130a or the second granulator unit 130b depending on, e.g., the availability of each of the granulator units 130. The GMU produced by each of the granulator units 130 can be transferred downstream via one or more conveyor belts that form part of the product handling unit 150. The fines produced by each of the granulator units 130 can be transferred to fines bunkers located adjacent to the granulator units 130 and ultimately sent to the loadout(s) 165. As shown in FIG. 3, the first dust collection unit 190a can be connected to each of the desulfurization unit 120 and the granulator units 130 via pipes to collect emissions therefrom.

Returning to FIG. 2, the cooling system 140 can be located adjacent to the granulator units 130 to provide cooling thereto as needed. The product handling unit 150 can include a stockpile area 252 for storing GMU products. One or more conveyor belts can extend between each of the granulator units 130 and the stockpile area 252, and between the stockpile area 252 and the loadout 155. In some embodiments, the loadout 155 comprises a building at which a desired quantity of GMUs can be measured and transferred to a railcar or other transfer vehicle. In some embodiments, the GMUs is subsequently transferred to an electric arc furnace (not shown) for steel production. The torpedo car 102, after delivering the molten metallics to the granulator units 130, can continue along the tracks to reach the torpedo prep unit 170. As discussed above with reference to FIG. 1, the torpedo prep unit 170 can facilitate removal of slag and/or kish from the torpedo car 102. The second dust collection unit 190b can be connected to the torpedo prep unit 170 via pipes to collect emissions therefrom.

Referring to FIGS. 1-3 together, the system 100 is expected to be able to continuously produce GMU, unlike conventional GMU production systems. First, the inclusion of the desulfurization unit 120 provides several advantages. For example, GMUs with lower sulfur content produces less slag when melted at an electric arc furnace downstream, saving associated time, costs, and energy consumption. For example, a relatively lower level of sulfur and/or carbon content can improve throughput and increase production of the downstream electric arc furnace (EAF) and/or ladle metallurgical furnace (LMF). The use of GMUs with lower sulfur content can also ease maintaining the desired chemical composition and temperature, reducing the frequency of adjustments and interruptions during the melting cycle. Lower sulfur levels can also result in less wear and tear on other components of the system, reducing maintenance needs and associated downtime.

Second, the inclusion of a plurality of granulator units 130 allows molten metallics to be granulated at separate granulator units in parallel. The granulator units 130 can also serve as backups for one another in case one of the granulator units 130 is down (e.g., due to malfunctioning components, maintenance, etc.) or in a turndown situation. Furthermore, in some embodiments, the various components of the granulator units 130 are modular. For example, each of the components can be easily and independently removed (e.g., for maintenance) and/or replaced (e.g., via an overhead crane) without impacting operation of the other components.

As discussed above, the system 100 is designed for continuous operation. Relative to non-continuous GPI production systems, embodiments of the present technology enhance energy efficiency and reduces emissions by minimizing the need for frequent shutdowns and restarts, which are often associated with excessive venting and/or less efficient operations. As described herein, some embodiments include (i) a desulfurization unit that lowers the sulfur content in molten metallics, thereby reducing sulfur dioxide (SO₂) emissions, (ii) dust collection units that filter out particulate matter, thereby reducing air pollution, (iii) infrastructure to recycle fines, slag, iron skulls and other residual and/or previously-processed metallics, thereby reducing the environmental impact associated with raw material extraction and conserving natural resources, and/or (iv) water management and cooling systems that minimize heat losses, enhance thermal efficiency of production processes, and optimize water consumption. Overall, the continuous GMU production system 100 enhances productivity while minimizing greenhouse gas emissions and waste, contributing to more sustainable industrial practices and helping mitigate climate change.

Relatedly, conventional iron production has a significant environmental impact due to its high energy consumption and emissions of pollutants. As such, embodiments of the present technology which relate to GMU production systems can reduce this impact. Sulfur, phosphorus, and silicon in GPI negatively affect the quality and properties of final metal products, leading to issues like reduced ductility, toughness, and weldability, as well as surface defects and brittleness. These impurities also contribute to the formation of non-metallic inclusions and excessive slag, complicating metal processing and compromising product quality. Sulfur, in particular, accelerates the wear and erosion of metal processing equipment, increasing maintenance costs and decreasing equipment lifespan. Embodiments of the present technology include methods for removing these impurities in part can improve the quality and durability of final metal products and enhances the efficiency and lifespan of processing equipment, leading to cost savings and more sustainable production practices.

### III. Embodiments of a Torpedo Car for Use with Granulated Metallic Unit Production

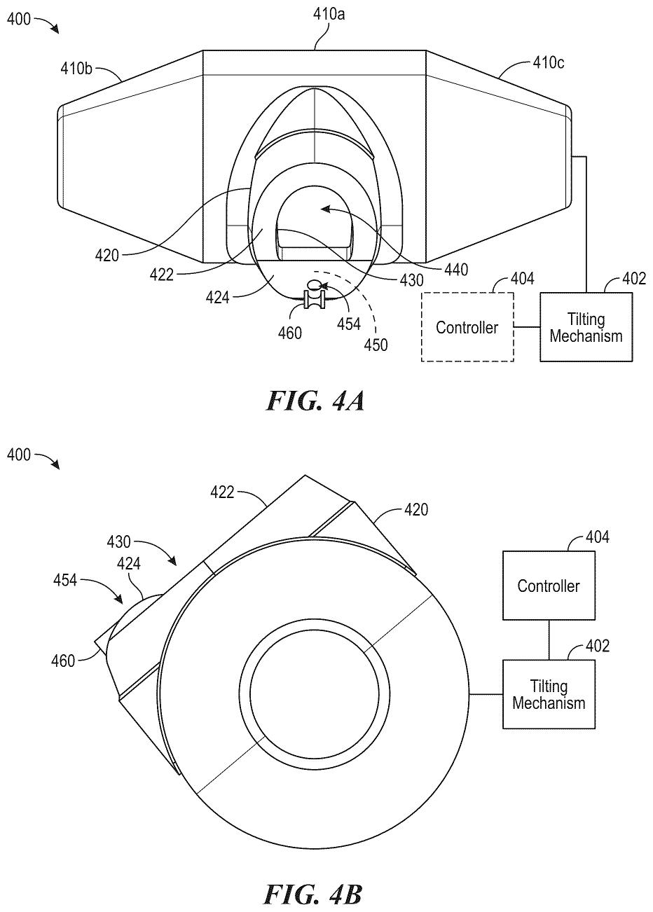

FIGS. 4A and 4B are top and side views, respectively, of a torpedo car 400 tilted and configured in accordance with embodiments of the present technology. A tilting mechanism 402 (shown schematically) can be rotatably coupled to the torpedo car 400, and a controller 404 (also shown schematically) can be operably coupled to the tilting mechanism 402. The torpedo car 400 can include a first body portion 410a, a second body portion 410b, and a third body portion 410c (collectively referred to as “the body 410”). In the illustrated embodiment, the first body portion 410a is substantially cylindrical, and each of the second and third body portions 410b, 410c is frustoconical and extending from the first body portion 410a, contributing to the torpedo shape of the body 410. It is appreciated that the torpedo car 400 can have other form factors in other embodiments. In some embodiments, the torpedo car 400 further includes a frame structure (not shown) with wheels so that the torpedo car 400 can travel on, e.g., rails. The tilting mechanism 402 can be integrated with the frame structure.

The torpedo car 400 can also include a protruded portion 420 coupled to and extending radially outward from one side of the body 410. As shown in FIG. 4A, the protruded portion 420 can have a width narrower than the first body portion 410a, and as shown in FIG. 4B, the protruded portion 420 can have a length substantially similar to the diameter of the first body portion 410a. The body 410 can have an inner surface defining a cavity 440, and the protruded portion 420 can include an inlet or opening 430 at an outer surface of the body 410 that provides access to a cavity 440 inside the body 410. In the illustrated embodiment, the opening 430 has a D-shape, although the opening 430 can have circular, elliptical, rectangular, triangular, or other shapes in other embodiments. The protruded portion 420 can also include a generally flat surface 422 around the opening 430, and a curved surface 424 adjacent to the generally flat surface 422. In some embodiments, the curved surface 424 is replaced by a flat surface or a surface of other shape. The torpedo car 400 can further include a pour spout or channel 450 (obscured in FIGS. 4A and 4B) that extends from the cavity 440 and out through the curved surface 424. The channel 450 can have an outlet 454 on the curved surface 424. In some embodiments, the torpedo car 400 additionally includes an extension member 460 coupled to the curved surface 424 adjacent to the outlet 454. In some embodiments, the maximum radius of the torpedo car 400 from the axis of rotation is sized to avoid the torpedo car 400 from hitting the rails on which the torpedo car 400 travels.

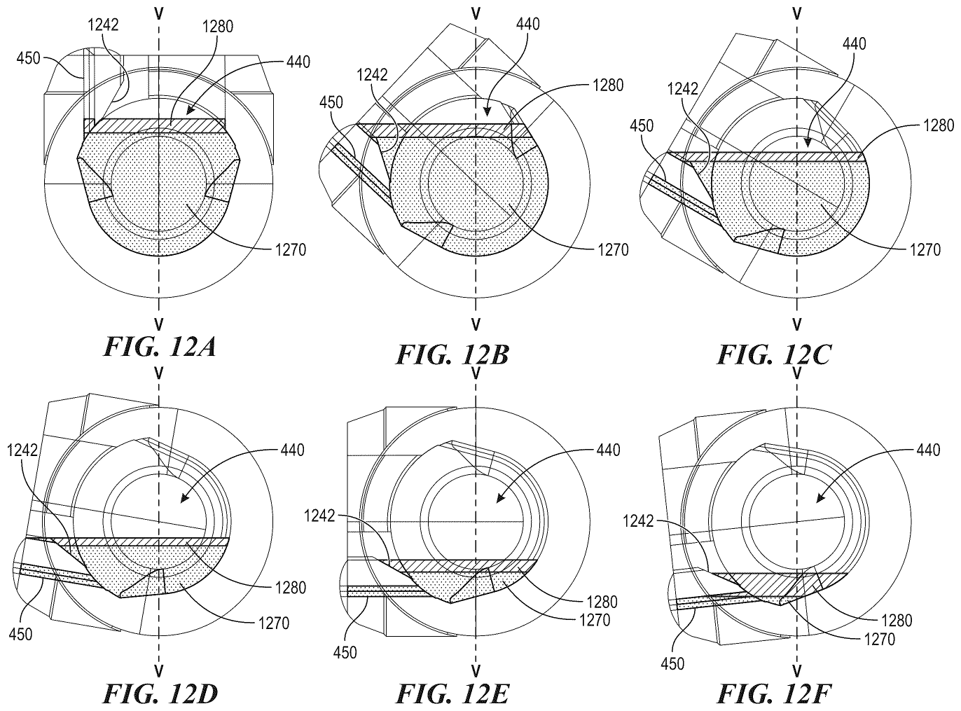

As discussed in further detail below with reference to FIGS. 12A-12F, a portion of the inner surface of the torpedo car 400 that defines the cavity 440 can serve as a skimmer or slag dam. As the tilting mechanism 402 tilts the torpedo car 400, the slag dam can keep slag and/or other impurities floating on top of the molten metallics from spilling out through the opening 430 or the channel 450.

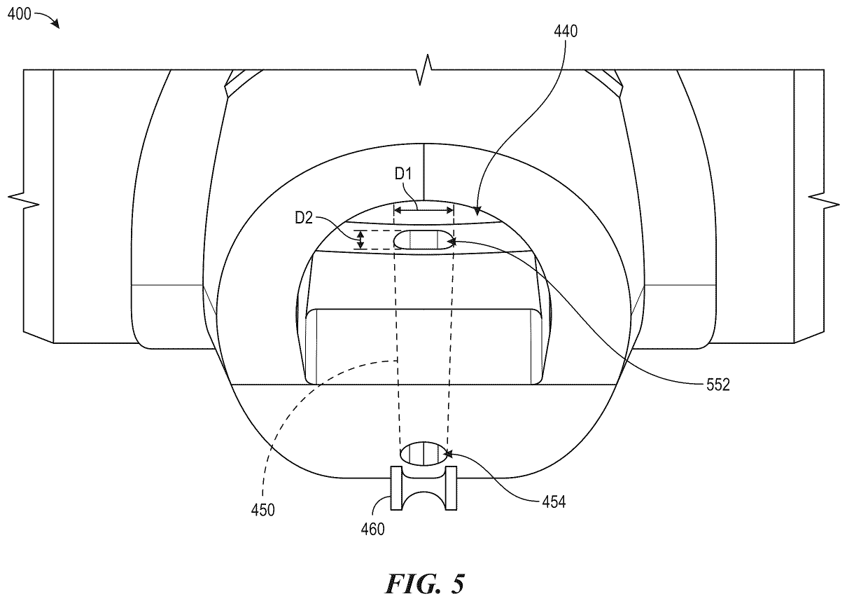

FIG. 5 is an enlarged view of the torpedo car 400. As shown, the torpedo car 400 can include a channel inlet 552 facing or interfacing the cavity 440. In the illustrated embodiment, the channel inlet 552 has an oblong-shaped cross-section having a width D1 and a height D2. The width D1 can be between 5-20 inches or between 7-15 inches, such as about 11 inches. The height D2 can be between 1-10 inches or between 3-7 inches, such as about 4 or 6 inches. The oblong shape with the relatively small height can help prevent slag or other impurities floating on the surface of the molten metal from entering the channel through the channel inlet 552 and from being poured into the granulator units 130, while allowing a sufficient flow rate of the molten metal therethrough. However, it will be appreciated that the channel inlet 552 can have circular, rectangular, elliptical, triangular, or other cross-sectional shapes in other embodiments. The channel 450 (obscured from view and illustrated with dashed lines in FIG. 5) can extend between the channel inlet 552 and the channel outlet 454. In some embodiments, the channel 450 extends substantially parallel to the protruded portion 420, and/or the opening 430.

In some embodiments, the channel 450 is formed via lost foam casting by melting and evaporating a pre-shaped foam insert (e.g., polystyrene). In other embodiments, the channel 450 is formed via machining and/or other suitable processes.

In operation, the torpedo car 400 can receive molten metal from, e.g., a blast furnace through the opening 430 and store the received molten metal in the cavity 440. The torpedo car 400 can have refractory lining or other suitable liner material along its inner surface to protect the torpedo car 400 from the molten metal stored in the cavity 440. The torpedo car 400 can then travel on rails while the protruded portion 420 is upright so that the opening 430 and the channel outlet 454 face generally upward, preventing the molten metal in the cavity 440 from spilling out. In some embodiments, the torpedo car 400 delivers or transports the molten metal to the desulfurization unit 120 at which the molten metal can be desulfurized while still in the cavity 440.

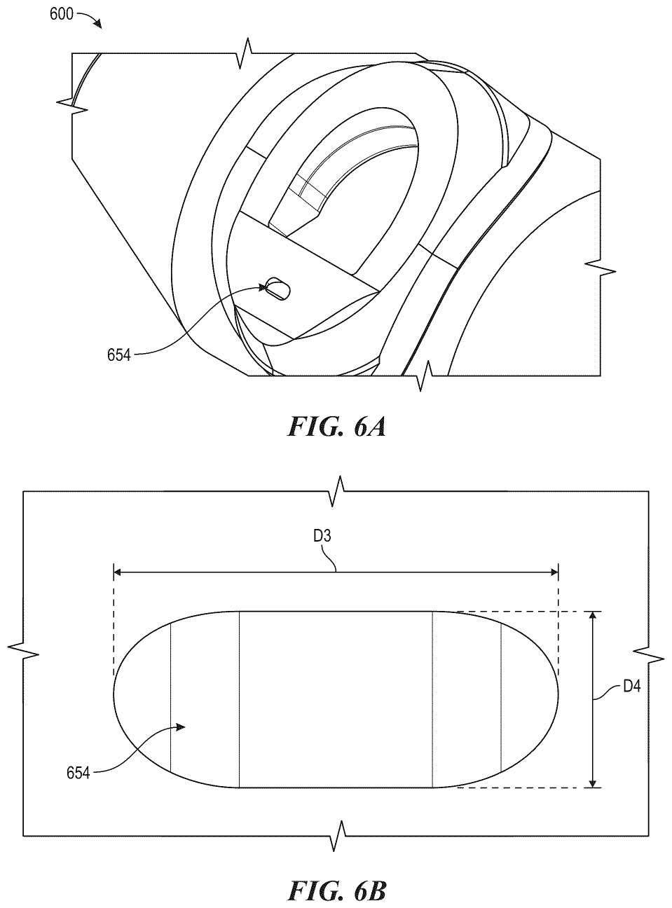

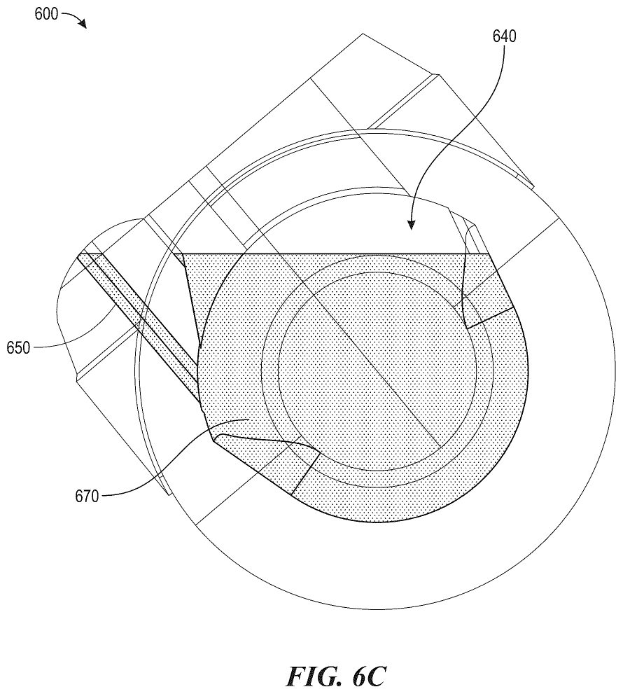

In some embodiments, the torpedo car 400 delivers or transports the molten metal to the granulator units 130 (or other unit) that can process and/or use the molten metal. The granulator unit 130 can include a runner, a tundish, a granulation reactor, and/or other device that can receive the molten metal from the torpedo car 400. Once at the granulator unit 130, the controller 404 can operate the tilting mechanism 402 to tilt the torpedo car so that the molten metal can flow out of the cavity 440 through the channel 450. The components of the granulator unit 130 (e.g., the runner, the tundish) can be positioned at a height at or below the rails of the torpedo car 400 so that as the torpedo car 400 tilts, the molten metal can pour into the components by virtue of gravity. As discussed further below with reference to FIGS. 6A-10B, the channel inlet 552 and the channel outlet 454 can have various cross-sectional shapes and dimensions to facilitate the flow of molten metal out of the torpedo car 400 in various controlled, desired manners.

FIGS. 6A, 6B, and 6C are enlarged perspective, enlarged front, and cross-sectional side views, respectively, of a torpedo car 600 having a first channel outlet shape and configured in accordance with embodiments of the present technology. In the illustrated embodiment, the torpedo car 600 has a channel outlet 654 having an oblong-shaped cross-section. As shown in FIG. 6B, the channel outlet 654 has a width D3 and a height D4. The width D3 can be between 5-20 inches or between 7-15 inches, such as about 11 inches. The height D4 can be between 1-10 inches or between 3-7 inches, such as about 4 or 6 inches. Accordingly, in embodiments in which the channel inlet also has an oblong-shaped cross-section, the channel outlet 654 can be substantially identical or similar in shape and size as the channel inlet.

Referring to FIG. 6C, molten metal 670 is illustrated occupying a portion of a cavity 640 and a channel 650 of the torpedo car 600. The torpedo car 600 is tilted to an angle at which the molten metal 670 can flow out of the cavity 640 via the channel 650. As shown, because the channel inlet and the channel outlet 654 have the same cross-sectional shape and dimensions, the channel 650 can have a substantially constant cross-sectional dimension along its length. It will be appreciated that in other embodiments, the channel inlet and the channel outlet 654 can have the same or similar cross-sectional shape but different cross-sectional dimensions such that the channel 650 widens or narrows along its length.

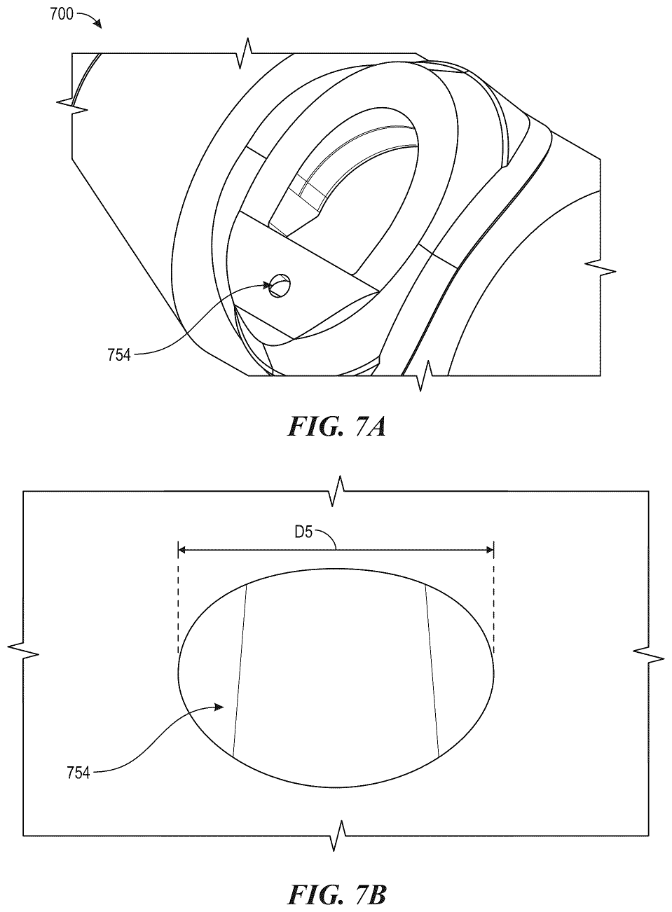

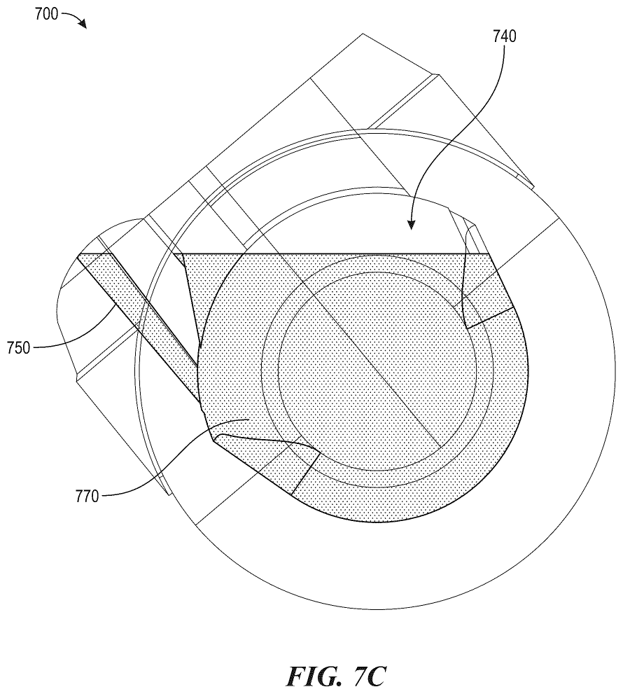

FIGS. 7A, 7B, and 7C are enlarged perspective, enlarged front, and cross-sectional side views, respectively, of a torpedo car 700 having a second channel outlet shape and configured in accordance with embodiments of the present technology. In the illustrated embodiment, the torpedo car 700 has a channel outlet 754 having a circular cross-section. As shown in FIG. 7B, the channel outlet 754 has a diameter D5. The diameter D5 can be between 1-20 inches or between 5-12 inches, such as about 8.6 inches. Accordingly, in embodiments in which the channel inlet has an oblong-shaped cross-section, the cross-sectional shape of the channel can vary along its length.

Referring to FIG. 7C, molten metal 770 is illustrated occupying a portion of a cavity 740 and a channel 750 of the torpedo car 700. The torpedo car 700 is tilted to an angle at which the molten metal 770 can flow out of the cavity 740 via the channel 750. As shown, because the channel outlet 754 has a greater height than the channel inlet, the channel 750 can have a gradually increasing height towards the channel outlet 754 along its length. For example, the channel inlet can have a height of 6 inches and the channel outlet 754 can have a diameter of 8.6 inches. Also, while not shown, the channel inlet can have a width of 11 inches and the channel 750 can have a gradually narrowing width towards the channel outlet 754 along its length. In the illustrated embodiment, the height of the channel 750 increases linearly along its length. It will be appreciated that the height (or other cross-sectional dimension) of the channel 750 can change non-linearly along its length.

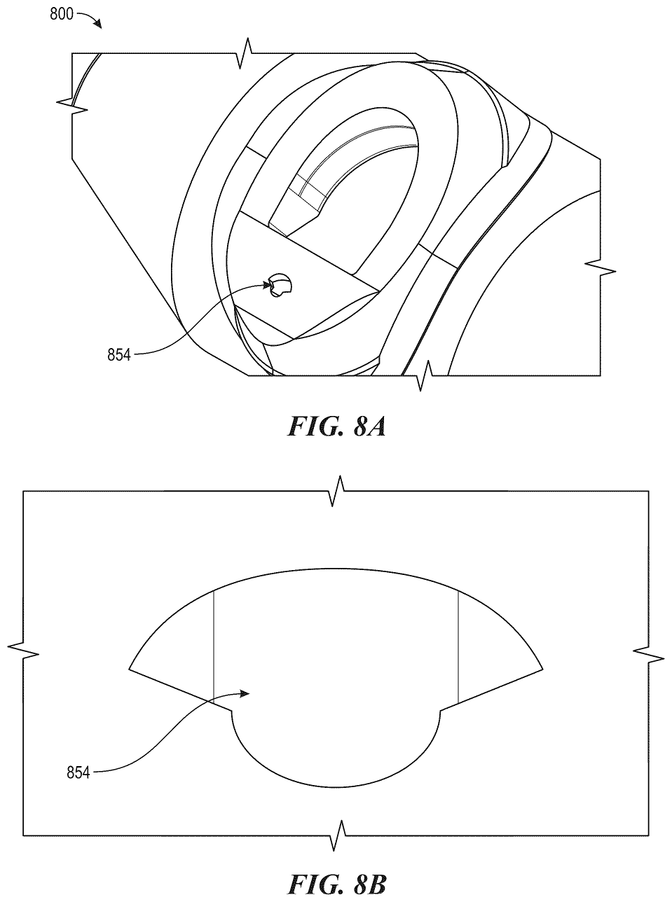

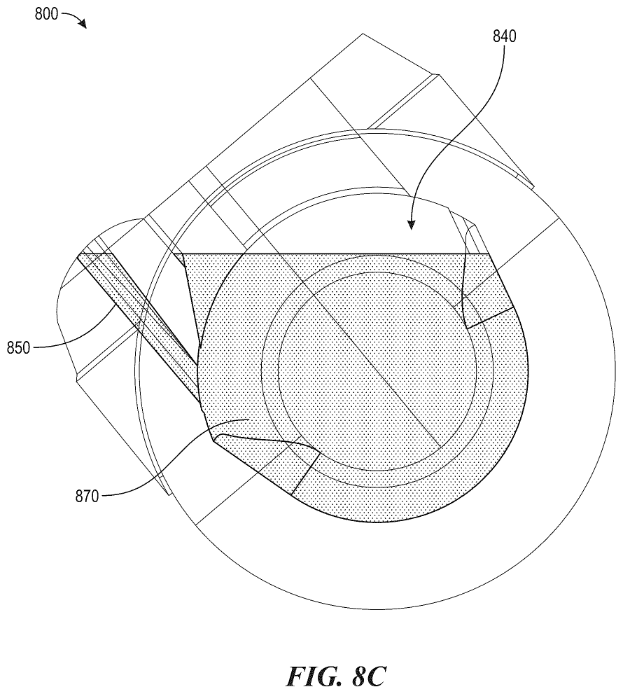

FIGS. 8A, 8B, and 8C are enlarged perspective, enlarged front, and cross-sectional side views, respectively, of a torpedo car 800 having a third channel outlet shape and configured in accordance with embodiments of the present technology. In the illustrated embodiment, the torpedo car 800 has a channel outlet 854 having a mushroom-shaped cross-section. Referring to FIG. 8C, molten metal 870 is illustrated occupying a portion of a cavity 840 and a channel 850 of the torpedo car 800. The torpedo car 800 is tilted to an angle at which the molten metal 870 can flow out of the cavity 840 via the channel 850. As shown, because the channel outlet 854 has a greater height than the channel inlet, the channel 850 can have a gradually increasing height towards the channel outlet 854 along its length. For example, the channel inlet can have a height of 6 inches and the channel outlet 854 can have a diameter of 10 inches. In the illustrated embodiment, the height of the channel 850 increases linearly along its length. It will be appreciated that the height (or other cross-sectional dimension) of the channel 850 can change non-linearly along its length.

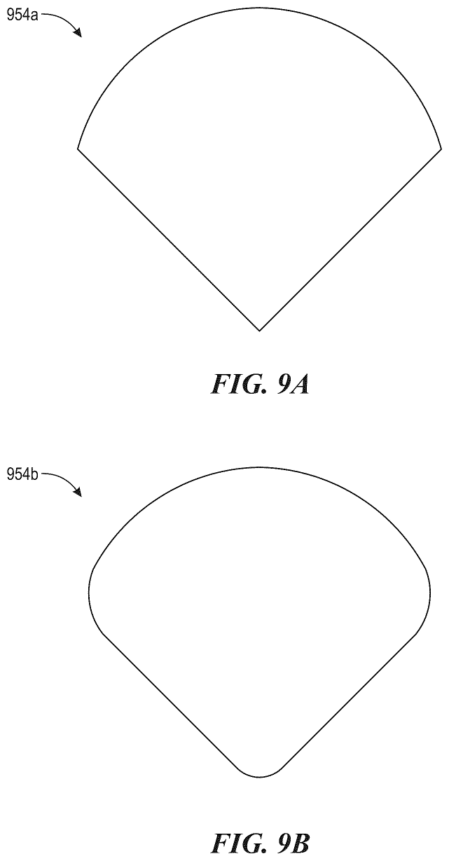

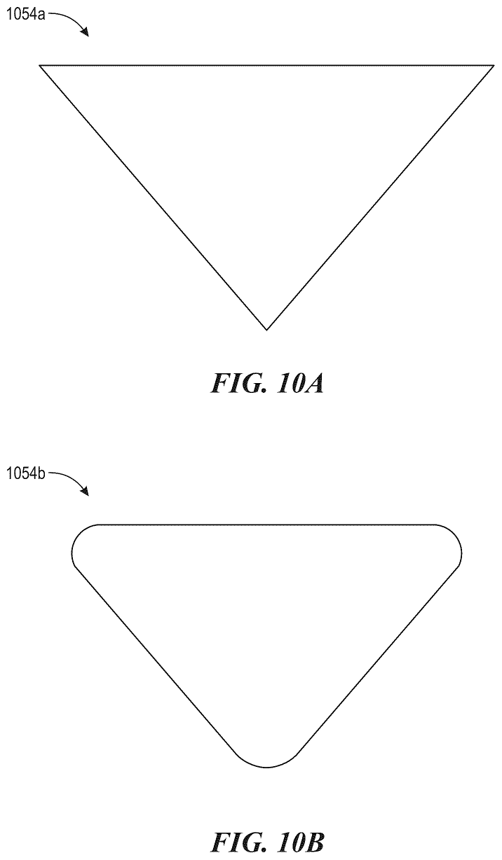

FIGS. 9A-10B illustrate various channel outlet shapes configured in accordance with embodiments of the present technology. FIG. 9A illustrates a channel outlet 954a having a sector-shaped cross-section. FIG. 9B illustrates a channel outlet 954b also having a sector-shaped cross-section, but without rounded corners. FIG. 10A illustrates a channel outlet 1054a having an upside-down triangle-shaped cross-section. FIG. 10B illustrates a channel outlet 1054b also having an upside-down triangle-shaped cross-section, but without rounded corners. Each of the channel outlets 954a, 954b, 1054a, 1054b has a narrow, cornered portion at the bottom that can help direct the flow of molten metal out of the torpedo car more precisely.

Referring to FIGS. 6A-10B together, it is appreciated that the illustrated channel outlet cross-section shapes are merely examples, and that the channel outlet can have triangular, rectangular, hexagonal, elliptical, or other shapes. Also, it is appreciated that the various shapes illustrated and described herein are not limited to the shape of the channel outlet, and can also apply to the shape of the channel inlet interfacing the cavity.

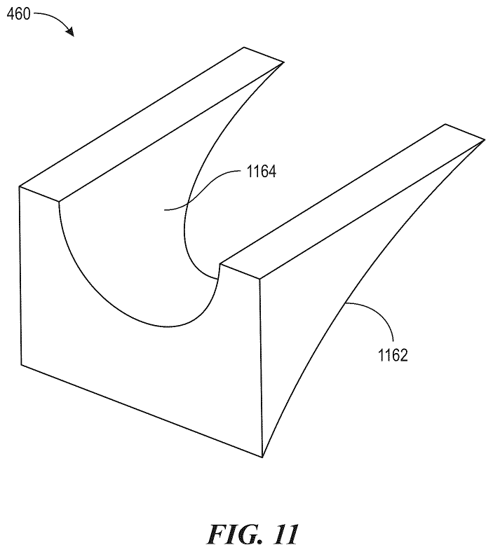

FIG. 11 is a perspective view of the extension member 460 coupleable to a torpedo car and configured in accordance with embodiments of the present technology. The extension member 460 can have a curved bottom surface 1162 shaped to align with the curvature of the curved surface 424 (FIGS. 4A and 4B), and a curved top surface 1164 shaped to facilitate flow of molten metal thereon. As illustrated in FIGS. 4A-5, the extension member 460 can be coupled to the torpedo car 400 (e.g., via fasteners, welding, etc.) such that the curved bottom surface 1162 interfaces the curved surface 424 and the curved top surface 1164 is positioned below and adjacent to the channel outlet 454.

In operation, as the tilting mechanism 402 tilts the torpedo car 400 and the molten metal begins to flow out of the channel 450, the molten metal may adhere to the curved surface 424 due to surface tension and adhesion forces instead of pouring straight downward into, e.g., a runner of the granulator units 130. The molten metal may dribble down without entering the runner, leading to material loss and overall inefficiency of the system 100. The extension member 460 can redirect the molten metal that may stick to the curved surface 424 and dribble down into the runner or other component of the granulator units 130. More specifically, the curved top surface 1164 can collect and pour the molten metal at a distance farther away from the center of the torpedo car 400, as shown in FIG. 4B.

FIGS. 12A-12F are cross-sectional side views of the torpedo car 400 tilted at various angles in accordance with embodiments of the present technology. More specifically, measured from a vertical axis V-V, FIG. 12A illustrates the torpedo car 400 not tilted (e.g., tilted by 0 degrees), FIG. 12B illustrates the torpedo car 400 tilted by 47 degrees, FIG. 12C illustrates the torpedo car 400 tilted by 60 degrees, FIG. 12D illustrates the torpedo car 400 tilted by 80 degrees, FIG. 12E illustrates the torpedo car 400 tilted by 90 degrees, and FIG. 12F illustrates the torpedo car 400 tilted by 96 degrees. As shown, the torpedo car 400 can include a slag dam 1242 that forms part of the inner surface defining the cavity 440. As discussed further herein, the slag dam 1242 can keep all or a significant portion of slag in the torpedo car 400 as the torpedo car 400 is tilted. The slag dam 1242 can have a flat, curved, and/or angled geometry to prevent or minimize the amount of slag that exits the torpedo car 400.

Referring first to FIG. 12A, molten metal 1270 can be transferred (e.g., poured) into the cavity 440 via the opening 430 (FIG. 4A). In some embodiments, slag 1280 is formed inside the torpedo car 400 during, e.g., a desulfurization process at the desulfurization unit 120 (FIG. 1). For example, sulfur-reducing agents can be added to the molten metallics 1270 in the torpedo car 400, and the resulting chemical reaction can generate the slag 1280 that floats on top of the molten metallics 1270. As shown, the protruded portion 420 and the channel 450 are oriented upright. Because the channel 450 is connected to the cavity 440 at the channel inlet, the molten metal 1270 and the slag 1280 can rise at least partially into the channel 450. The cavity 440 may not be fully filled up to allow the torpedo car 400 to tilt by a minimum angle before pouring the molten metal 1270 out through the channel 450. The mass of the molten metal 1270 can be between 50-1,000 metric tons, between 70-500 metric tons, or between 100-150 metric tons, such as about 120 metric tons. The mass of the slag 1280 can be between 1-100 metric tons or between 1-10 metric tons, such as about 4 metric tons.

Referring next to FIG. 12B, the illustrated orientation of the torpedo car 400, tilted by 47 degrees from the vertical axis V-V, can be the maximum angle before the molten metal 1270 and/or the slag 1280 pours out of the torpedo car 400. It is appreciated that this threshold tilt angle can depend on how much molten metal and/or slag is in the torpedo car 400, the geometry of the torpedo car 400, etc. For example, in some embodiments, the torpedo car 400 can be shaped such that the molten metal 1270 begins exiting the channel outlet when the torpedo car 400 is tilted by angle between 40-60 from the vertical axis V-V and when the torpedo car 400 stores a mass of molten metal between 100-150 metric tons. As shown, the slag dam 1242 can keep the slag 1280 within the torpedo car 400 as the torpedo car 400 is tilted.

Referring next to FIG. 12C, the torpedo car 400 is tilted by 60 degrees from the vertical axis V-V. A portion of the molten metal 1270 may have exited the torpedo car 400 via the channel 450. For example, the mass of the molten metal 1270 remaining in the torpedo car 400 may have decreased from about 120 metric tons (in FIGS. 12A and 12B) to about 96 metric tons. Also, while a small amount of the slag 1280 initially present in the channel 450 (as shown in FIG. 12A) may have come out of the channel 450, this amount can be negligible and the slag dam 1242 can keep nearly all of the slag 1280 in the cavity 440, floating on top of the molten metal 1270, as shown.

Referring next to FIG. 12D, the torpedo car 400 is tilted by 80 degrees from the vertical axis V-V. More of the molten metal 1270 may have exited the torpedo car 400 via the channel 450. For example, the mass of the molten metal 1270 remaining in the torpedo car 400 may have decreased from about 120 metric tons (in FIGS. 12A and 12B) to about 50 metric tons. The slag dam 1242 can keep nearly all of the slag 1280 in the cavity 440, floating on top of the molten metal 1270, as shown.

Referring next to FIG. 12E, the torpedo car 400 is tilted by 90 degrees from the vertical axis V-V. More of the molten metal 1270 may have exited the torpedo car 400 via the channel 450. For example, the mass of the molten metal 1270 remaining in the torpedo car 400 may have decreased from about 120 metric tons (in FIGS. 12A and 12B) to about 24 metric tons. The slag dam 1242 can keep nearly all of the slag 1280 in the cavity 440, floating on top of the molten metal 1270, as shown.

Referring finally to FIG. 12F, the torpedo car 400 is tilted by 90 degrees from the vertical axis V-V. More of the molten metal 1270 may have exited the torpedo car 400 via the channel 450. For example, the mass of the molten metal 1270 remaining in the torpedo car 400 may have decreased from about 120 metric tons (in FIGS. 12A and 12B) to about 1 metric ton. While the slag dam 1242 can prevent the slag 1280 from exiting the cavity 440 via the opening 430 (FIG. 4A), a portion of the slag 1280 can begin to exit the cavity 440 via the channel 450. Therefore, the illustrated angle can represent the point at which the slag 1280 begins to exit the torpedo car 400 via the channel 450 and the torpedo car 400 can cease to tilt any further.

Referring to FIGS. 12A-12F together, as shown, the slag dam 1242 can retain nearly all of the slag 1280 in the cavity 440 as the torpedo car 400 is tilted at various angles. This allows the material exiting the torpedo car 400 via the channel 450 to be nearly 100% molten metallics and nearly no slag, which can improve the downstream flow control and the material properties of the resulting granulated iron.

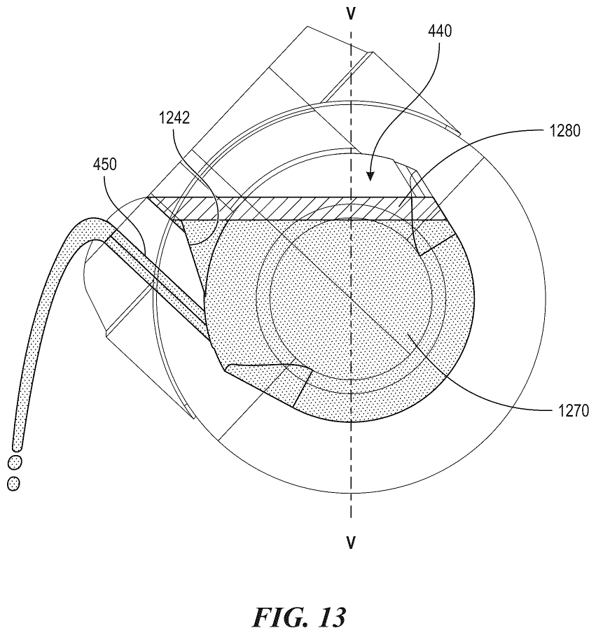

FIG. 13 is a cross-sectional side view of the torpedo car 400 tilted to pour molten metallics out in accordance with embodiments of the present technology. As shown, the molten metallics 1270 can pour out of the cavity 440 via the channel 450 in an arched path (e.g., a parabola). Advantageously, pouring the molten metallics 1270 out in the illustrated arched path as opposed to, e.g., pouring the molten metallics 1270 out such that the molten metallics 1270 dribbles out and sticks to the external surface of the torpedo car 400, can reduce material loss and/or slag buildup on the torpedo car 400. In some embodiments, the velocity of the molten metallics 1270 exiting the torpedo car 400 can be between 0-10 m/s or between 0-5 m/s.

### IV. Methods for Operating a Torpedo Car for Use with Granulated Metallic Units

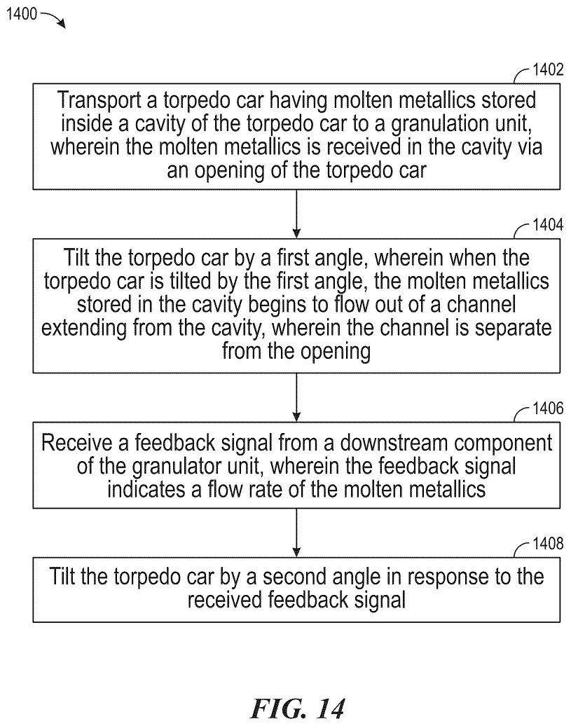

FIG. 14 is a flowchart illustrating a method 1400 for operating a torpedo car for use with granulated iron production in accordance with embodiments of the present technology. While the steps of the method 1400 are described below in a particular order, one or more of the steps can be performed in a different order or omitted, and the method 1400 can include additional and/or alternative steps. Additionally, although the method 1400 may be described below with reference to the embodiments of the present technology described herein, the method 1400 can be performed with other embodiments of the present technology.

The method 1400 begins at block 1402 by transporting a torpedo car having molten metal stored inside a cavity of the torpedo car to a granulation unit, wherein the molten metal is received in the cavity via an opening of the torpedo car. In some embodiments, transporting comprises transporting the torpedo car having a mass of molten metal between 100-150 metric tons.

At block 1404, the method 1400 continues by tilting the torpedo car by a first angle, wherein when the torpedo car is tilted by the first angle, the molten metal stored in the cavity begins to flow out of a channel extending from the cavity, wherein the channel is separate from the opening. In some embodiments, the first angle is between 40-60 degrees from a vertical axis.

At block 1406, the method 1400 continues by receiving a feedback signal from a downstream component of the granulator unit, wherein the feedback signal is associated with a flow rate of the molten metallics. Thus, the tilting of the torpedo car can be integrated in a feedback loop that, e.g., uses various measurements taken downstream of the torpedo car. In some embodiments, receiving comprises receiving a surface level measurement of molten metal in a runner positioned downstream of the torpedo car. In some embodiments, receiving comprises receiving a weight measurement of molten metal in a runner positioned downstream of the torpedo car. In some embodiments, receiving comprises receiving optical granulometry analysis results from an imaging sensor positioned downstream of the torpedo car to image granulated iron produced using the molten metal from the torpedo car.

At block 1408, the method 1400 continues by tilting the torpedo car by a second angle in response to the received feedback signal. In some embodiments, the angle is continuously or iteratively adjusted or updated based on a continuous stream of feedback signals. For example, the tilt angle of the torpedo car can be adjusted in real-time based on the received feedback signal.

### V. Examples

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner.
1. A torpedo car for use with granulated metallic unit production, the torpedo car comprising:
   a tilting mechanism;
   a body rotatably coupled to the tilting mechanism, where the body includes an inner surface and an outer surface, wherein the inner surface defines a cavity and a channel, wherein the outer surface defines an opening to the cavity and a channel outlet of the channel spaced apart from the opening, wherein the cavity is configured to store molten metal received through the opening and slag, and wherein the channel extends between the channel outlet and a channel inlet interfacing the cavity; and
   a controller operably coupled to the tilting mechanism to control tilting of the body such that as the body tilts, the molten metal flows out of the cavity through the channel.
2. The torpedo car of any of the examples herein, wherein a portion of the inner surface defining the cavity comprises a slag dam configured to prevent the slag from exiting the cavity.
3. The torpedo car of any of the examples herein, wherein the channel inlet and the channel outlet have a same cross-sectional shape.
4. The torpedo car of any of the examples herein, wherein the channel inlet and the channel outlet have same cross-sectional dimensions.
5. The torpedo car of any of the examples herein, wherein the channel inlet and the channel outlet have different cross-sectional shapes.
6. The torpedo car of any of the examples herein, wherein the channel inlet and the channel outlet have different cross-sectional dimensions.
7. The torpedo car of any of the examples herein, wherein the channel has a constant cross-section along a length of the channel.
8. The torpedo car of any of the examples herein, wherein the channel has a varying cross-section along a length of the channel.
9. The torpedo car of any of the examples herein, wherein the channel inlet has an oblong-shaped cross-section.
10. The torpedo car of any of the examples herein, wherein the oblong-shaped cross-section of the channel inlet has a width between 7-15 inches and a height between 3-7 inches.
11. The torpedo car of any of the examples herein, wherein the channel outlet has an oblong-shaped cross-section.
12. The torpedo car of any of the examples herein, wherein the oblong-shaped cross-section of the channel outlet has a width between 7-15 inches and a height between 3-7 inches 13. The torpedo car of any of the examples herein, wherein the channel outlet has a circular cross-section.
14. The torpedo car of any of the examples herein, wherein the circular cross-section of the channel outlet has a diameter between 5-12 inches.
15. The torpedo car of any of the examples herein, wherein the channel outlet has a mushroom-shaped cross-section.
16. The torpedo car of any of the examples herein, wherein the channel outlet has a sector-shaped cross-section.
17. The torpedo car of any of the examples herein, wherein the channel outlet has a triangular cross-section.
18. The torpedo car of any of the examples herein, wherein the channel is parallel to the opening.
19. The torpedo car of any of the examples herein, further comprising an extension member coupled to the outer surface of the body adjacent to the channel outlet, wherein the extension member is configured to collect and facilitate pouring of the molten metal coming out of the channel outlet.
20. The torpedo car of any of the examples herein, wherein the torpedo car is shaped such that the molten metal begins exiting the channel outlet when the torpedo car is tilted by angle between 40-60 from a vertical axis and when the torpedo car stores a mass of molten metal between 100-150 metric tons.
21. The torpedo car of any of the examples herein, wherein the slag dam is configured to prevent the slag from exiting the cavity via the opening as the torpedo car is tilted and the molten metal flows out of the cavity through the channel.
22. A method for operating a torpedo car for use granulated metallic unit production, the method comprising:
   transporting a torpedo car having molten metal stored inside a cavity of the torpedo car to a granulation unit, wherein the molten metal is received in the cavity via an opening of the torpedo car;
   tilting the torpedo car by a first angle, wherein when the torpedo car is tilted by the first angle, the molten metal stored in the cavity begins to flow out of a channel extending from the cavity, wherein the channel is separate from the opening;
   receiving a feedback signal from a downstream component of the granulator unit, wherein the feedback signal is associated with a flow rate of the molten metal; and
   tilting the torpedo car by a second angle in response to the received feedback signal.
23. The method of any of the examples herein, wherein slag in the cavity remains therein as the torpedo car is tilted to the first angle or the second angle.
24. The method of any of the examples herein, wherein a slag dam of the torpedo car is configured to keep slag in the cavity therein as the torpedo car is tilted to the first angle or the second angle.
25. The method of any of the examples herein, wherein transporting comprises transporting the torpedo car having a mass of molten metal between 70-500 metric tons or between 100-150 metric tons.
26. The method of any of the examples herein, wherein the first angle is between 40-60 degrees from a vertical axis.
27. The method of any of the examples herein, wherein receiving comprises receiving a surface level measurement of molten metal in a runner positioned downstream of the torpedo car.
28. The method of any of the examples herein, wherein receiving comprises receiving a weight measurement of molten metal in a runner positioned downstream of the torpedo car.
29. The method of any of the examples herein, wherein receiving comprises receiving optical granulometry analysis results from an imaging sensor positioned downstream of the torpedo car to image granulated iron produced using the molten metal from the torpedo car.

### V. Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing concentrations, shear strength, and other numerical values used in the specification and claims, are to be understood as being modified in all instances by the term “about.” “About” as used herein can represent a range of plus or minus 10% of the stated value. Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

I/We claim:

1. A torpedo car for use with granulated iron production, the torpedo car comprising:
a tilting mechanism;
a body rotatably coupled to the tilting mechanism, where the body includes an inner surface and an outer surface, wherein the inner surface defines a cavity and a channel, wherein the outer surface defines an opening to the cavity and a channel outlet of the channel spaced apart from the opening, wherein the cavity is configured to store molten metal received through the opening and slag, and wherein the channel extends between the channel outlet and a channel inlet interfacing the cavity; and
a controller operably coupled to the tilting mechanism to control tilting of the body such that as the body tilts, the molten metal flows out of the cavity through the channel.

2. The torpedo car of claim 1, wherein a portion of the inner surface defining the cavity comprises a slag dam configured to prevent the slag from exiting the cavity.

3. The torpedo car of claim 1, further comprising a refractory edge forming a slag man adjacent the opening.

4. The torpedo car of claim 1, wherein the channel inlet and the channel outlet have different cross-sectional dimensions.

5. The torpedo car of claim 1, wherein the channel has a constant cross-section along a length of the channel.

6. The torpedo car of claim 1, wherein the channel has a varying cross-section along a length of the channel.

7. The torpedo car of claim 1, wherein the channel inlet has an oblong-shaped cross-section having a width between 7-15 inches and a height between 3-7 inches.

8. The torpedo car of claim 1, wherein the channel outlet has an oblong-shaped cross-section having a width between 7-15 inches and a height between 3-7 inches.

9. The torpedo car of claim 1, wherein the channel outlet has a circular cross-section having a diameter between 5-12 inches.

10. The torpedo car of claim 1, wherein the channel outlet has a mushroom-shaped, a sector-shaped, or triangular cross-section.

11. The torpedo car of claim 1, further comprising an extension member coupled to the outer surface of the body adjacent to the channel outlet, wherein the extension member is configured to collect and facilitate pouring of the molten metal coming out of the channel outlet.

12. The torpedo car of claim 1, wherein the torpedo car is shaped such that the molten metal begins exiting the channel outlet when the torpedo car is tilted by angle between 40-60 from a vertical axis, and wherein the torpedo car stores a mass of molten metal between 100-150 metric tons.

13. The torpedo car of claim 1, wherein the torpedo car is configured to keep slag within the cavity as the torpedo car is tilted and the molten metal flows out of the cavity through the channel.

14. A method for operating a torpedo car for use granulated iron production, the method comprising:
transporting a torpedo car having molten metal stored inside a cavity of the torpedo car to a granulation unit, wherein the molten metal is received in the cavity via an opening of the torpedo car;
tilting the torpedo car by a first angle, wherein when the torpedo car is tilted by the first angle, the molten metal stored in the cavity begins to flow out of a channel extending from the cavity, wherein the channel is separate from the opening;
receiving a feedback signal from a downstream component of the granulator unit, wherein the feedback signal is associated with a flow rate of the molten metal; and
tilting the torpedo car by a second angle in response to the received feedback signal.

15. The method of claim 14, wherein the torpedo car includes a slag dam, the method further comprising preventing, via the slag dam, slag in the cavity from exiting the torpedo car as the torpedo car is tilted to the first angle or the second angle.

16. The method of claim 14, wherein transporting comprises transporting the torpedo car having a mass of molten metal between 100-150 metric tons.

17. The method of claim 14, wherein the first angle is between 40-60 degrees from a vertical axis.

18. The method of claim 14, wherein receiving comprises receiving a surface level measurement of molten metal in a runner positioned downstream of the torpedo car.

19. The method of claim 14, wherein receiving comprises receiving a weight measurement of molten metal in a runner positioned downstream of the torpedo car.

20. The method of claim 14, wherein receiving comprises receiving optical granulometry analysis results from an imaging sensor positioned downstream of the torpedo car to image granulated iron produced using the molten metal from the torpedo car.
